(19) United States
(12) Patent Application Publication
(10) Pub. No.: US 2026/0311044 A1
(43) Pub. Date: Oct. 8, 2026

(54) Meta-Optimization of Training Data Distribution for Machine-Learned Models

(71) Applicant: GDM Holding LLC, Mountain View, CA (US)

(72) Inventors: Dan-Andrei Calian, London (GB); David Silver, Mountain View, CA (US); Iurii Kemaev, London (GB); Hado Philip van Hasselt, Utrecht (NL); Gregory Robert Farquhar, London (GB); Jeffrey Adgate Dean, Palo Alto, CA (US); Luisa Maria Zintgraf, London (GB)

(21) Appl. No.: 19/173,572

(22) Filed: Apr. 8, 2025

(51) Int. Cl. G06N 20/00

(52) U.S. Cl. CPC G06N 20/00

(57) ABSTRACT

Provided are systems and methods that optimize the selection for machine-learned models, a task that has traditionally depended on heuristic methods. Specifically, provided is an example method that utilizes a machine-learned data rating model to evaluate and score the quality of individual data instances within a training corpus. This model enables a more dynamic and performance-oriented selection of training data. For example, in each meta-optimization iteration, training data information is processed to generate training data scores, which are then used to select a subset of training data for model training. The performance of the trained model is subsequently evaluated, and the findings are used to update the machine-learned data rating model, refining its ability to assess data quality.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect is directed to a computer-implemented method, comprising: for each of a plurality of meta-optimization iterations: obtaining, by a computing system comprising one or more computing devices, training data information descriptive of one or more training data instances included in a corpus of training data instances; processing, by the computing system, the training data information descriptive of the one or more training data instances with a machine-learned data rating model to generate one or more training data scores respectively for the one or more training data instances; selecting, by the computing system, a selected subset of training data instances from the corpus of training data instances based on the one or more training data scores; training, by the computing system, a subject machine-learned model on the selected subset of training data; after or during training the subject machine-learned model on the selected subset of training data, evaluating, by the computing system, model performance data for the subject machine-learned model; and updating, by the computing system, the machine-learned data rating model based at least in part on the model performance data.

Example implementations can include combinations of one or more of the following features. In some implementations, the training data information comprises the one or more training data instances. In some implementations, the training data information comprises metadata associated with the one or more training data instances. In some implementations, the corpus of training data instances comprises training data instances having multiple different modalities. In some implementations, the corpus of training data instances comprises training data instances having multiple different data sources. In some implementations, the corpus of training data instances comprises a mixture of real training data instances and synthetic training data instances. In some implementations, selecting, by the computing system, a selected subset of training data instances from the corpus of training data instances based on the one or more training data scores comprises probabilistically sampling, by the computing system, each training data instance from the corpus of training data instances with a probability according to its corresponding training data score. In some implementations, processing, by the computing system, the training data information with the machine-learned data rating model to generate the one or more training data scores comprising conditioning, by the computing system, the machine-learned data rating model on model state data descriptive of a model state of the subject machine-learned model. In some implementations, the method further comprises: inserting, by the computing system into the corpus of training instances and during the plurality of meta-optimization iterations, one or more newly-generated training instances that contain outputs generated by the subject machine-learned model during one of the meta-optimization iterations. In some implementations, further comprising, after the plurality of meta-optimization iterations: outputting, by the computing system, an optimized subset of training data instances that have been selected based on a final set of training data scores generated by a final version of the machine-learned data rating model. In some implementations, the method further comprises: training, by the computing system, a target machine-learned model using the optimized subset of training data instances. In some implementations, the target machine-learned model is the subject machine-learned model. In some implementations, the target machine-learned model is different from the subject machine-learned model, and wherein the target machine-learned model one of both of: contains more parameters as compared to the subject machine-learned model and consumes additional processor cycles to process an input as compared to the subject machine-learned model. In some implementations, the target machine-learned model has at least 2, 5, 10, or 100 times as many parameters as compared to the subject machine-learned model. In some implementations, evaluating, by the computing system, the model performance data for the subject machine-learned model comprises evaluating, by the computing system, one or more performance metrics of the subject machine-learned model relative to a validation dataset. In some implementations, evaluating, by the computing system, the model performance data for the subject machine-learned model is performed prior to convergence of the subject machine-learned model when training, by the computing system, the subject machine-learned model on the selected subset of training data. In some implementations, updating, by the computing system, the machine-learned data rating model based at least in part on the model performance data comprises performing, by the computing system, a meta-gradient optimization technique. In some implementations, the meta-gradient optimization technique uses a meta-optimization loss function, wherein the meta-optimization function is a same loss function as is used when training, by the computing system, the subject machine-learned model on the selected subset of training data. In some implementations, updating, by the computing system, the machine-learned data rating model based at least in part on the model performance data comprises performing, by the computing system, an evolutionary learning technique to update the machine-learned data rating model. In some implementations, updating, by the computing system, the machine-learned data rating model based at least in part on the model performance data comprises performing, by the computing system, an evolutionary strategies technique to update the machine-learned data rating model. In some implementations, updating, by the computing system, the machine-learned data rating model based at least in part on the model performance data comprises performing, by the computing system, a reinforcement learning technique to update the machine-learned data rating model. In some implementations, the training data instances included in the corpus of training data instances comprise one or both of: multiple different single-modality training data instances respectively corresponding to multiple different data modalities; and one or more multi-modal training data instances each corresponding to multiple different data modalities.

Another example aspect is directed to a computing system comprising one or more processors and one or more non-transitory computer-readable media that collectively store computer-executable instructions for performing operations, the operations comprising: for each of a plurality of meta-optimization iterations: obtaining, by the computing system, training data information descriptive of one or more training data instances included in a corpus of training data instances; processing, by the computing system, the training data information descriptive of the one or more training data instances with a machine-learned data rating model to generate one or more training data scores respectively for the one or more training data instances; selecting, by the computing system, a selected subset of training data instances from the corpus of training data instances based on the one or more training data scores; training, by the computing system, a subject machine-learned model on the selected subset of training data; after or during training the subject machine-learned model on the selected subset of training data, evaluating, by the computing system, model performance data for the subject machine-learned model; and updating, by the computing system, the machine-learned data rating model based at least in part on the model performance data.

Another example aspect is directed to one or more non-transitory computer-readable media that collectively store a target machine-learned model, wherein the target machine-learned model has been trained on an optimized subset of training instances that were selected based on performance of operations, the operations comprising: for each of a plurality of meta-optimization iterations: obtaining, by a computing system, training data information descriptive of one or more training data instances included in a corpus of training data instances; processing, by the computing system, the training data information descriptive of the one or more training data instances with a machine-learned data rating model to generate one or more training data scores respectively for the one or more training data instances; selecting, by the computing system, a selected subset of training data instances from the corpus of training data instances based on the one or more training data scores; training, by the computing system, a subject machine-learned model on the selected subset of training data; after or during training the subject machine-learned model on the selected subset of training data, evaluating, by the computing system, model performance data for the subject machine-learned model; and updating, by the computing system, the machine-learned data rating model based at least in part on the model performance data.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1A is a graphical diagram illustrating an example system for optimizing training data selection for machine-learned models according to example implementations of aspects of the present disclosure;

FIG. 1B is a graphical diagram illustrating an example system for optimizing multi-modal training data selection for machine-learned models according to example implementations of aspects of the present disclosure;

FIG. 2 is a flow chart diagram illustrating an example method for optimizing training data selection and model training according to example implementations of aspects of the present disclosure;

FIG. 3 is a flow chart diagram illustrating an example method for training a machine-learned model according to example implementations of aspects of the present disclosure;

FIG. 4 is a block diagram of an example processing flow for using machine-learned model(s) to process input(s) to generate output(s) according to example implementations of aspects of the present disclosure;

FIG. 5 is a block diagram of an example sequence processing model according to example implementations of aspects of the present disclosure;

FIG. 6 is a block diagram of an example technique for populating an example input sequence for processing by a sequence processing model according to example implementations of aspects of the present disclosure;

FIG. 7 is a block diagram of an example model development platform according to example implementations of aspects of the present disclosure;

FIG. 8 is a block diagram of an example training workflow for training a machine-learned model according to example implementations of aspects of the present disclosure;

FIG. 9 is a block diagram of an inference system for operating one or more machine-learned model(s) to perform inference according to example implementations of aspects of the present disclosure;

FIG. 10 is a block diagram of an example networked computing system according to example implementations of aspects of the present disclosure;

FIG. 11 is a block diagram of an example computing device according to example implementations of aspects of the present disclosure; and

FIG. 12 is a block diagram of an example computing device according to example implementations of aspects of the present disclosure.

### DETAILED DESCRIPTION

Example aspects of the present disclosure optimize the selection of training data for machine-learned models. In particular, example aspects of the present disclosure are directed to a meta-optimization approach in which training data is curated by a data rating model that is used to score training data instances with respect to data quality or usefulness.

In particular, current data curation pipelines available in the art often incorporate heuristic-based filtering and deduplication techniques to mitigate the inclusion of low-quality or redundant data. For example, simple rules might remove documents based on length, presence of certain keywords, or statistical measures of text quality. Near-duplicate detection algorithms are often employed to reduce redundancy within the training corpus. These methods, while helpful, have inherent limitations.

A significant drawback of current methods lies in their reliance on static data mixtures and predetermined filtering rules. The relative importance of different data sources or the effectiveness of specific filters may vary throughout the training process, yet these aspects are rarely adapted dynamically. Furthermore, heuristic filters are often based on easily computable proxies for data quality, which may not correlate strongly with actual training performance. The inherent subjectivity in designing these heuristics can introduce biases and lead to suboptimal data selection strategies.

Another limitation is the inability to account for the evolving state of the machine-learned model during training. The usefulness of a particular data point can be highly dependent on the model’s current knowledge and capabilities. Data that is highly informative early in training might become less valuable as the model converges. Similarly, data that challenges the model with difficult or ambiguous examples may be more beneficial during later stages of training. Existing approaches lack the ability to adapt the training data distribution based on the model’s learning trajectory.

In view of the above technical challenges, the present disclosure introduces systems and methods that utilize a machine-learned data rating model to evaluate and score the quality of individual data instances within a training corpus. This model enables a more dynamic and performance-oriented selection of training data. For example, the proposed techniques can operate iteratively over a plurality of meta-optimization iterations. In each meta-optimization iteration, training data information descriptive of available training instances is processed by the machine-learned data rating model to generate training data scores. These training data scores can then be used to select a subset of training data for training a subject machine-learned model. The performance of the trained subject model is subsequently evaluated, and the findings are used to update the machine-learned data rating model, refining its ability to assess data quality in future meta-optimization iterations.

One of the benefits of this technique is its ability to continuously adapt the training data selection process based on empirical performance metrics, potentially leading to more efficient model training. The method can be applied to various types of training data, including data from multiple modalities and/or sources, as well as a mix of real and synthetic data instances. This flexibility allows for broad applicability across different machine learning tasks and model architectures.

Thus, the present disclosure performs training data selection that is grounded in performance optimization rather than fixed heuristics. The proposed techniques can enhance the efficiency and effectiveness of training machine-learned models (e.g., foundational models such as large language models, large multimodal models, or similar).

More particularly, a corpus of training data instances can include a large number of different training data instances. Each training data instance can include one or more values for each of a plurality of features (e.g., one or more words or other tokens). The training data instances can be collected from a number of different data sources, such as webpages, code repositories, and/or corpora or knowledge bases.

In some implementations, the corpus of training data instances can include data from multiple different modalities and/or from various data sources, and it can include both real and synthetic training data instances. For example, the data modalities might range from textual and visual to auditory, allowing the system to handle and process a diverse set of data types. Additionally, these data instances could originate from different sources such as online articles, social media platforms, scientific journals, or generated datasets. The inclusion of synthetic data, which is artificially created rather than obtained through direct observation, can be particularly beneficial for augmenting the training set in scenarios where real data is scarce or lacks variability.

At each meta-optimization iteration, a computing system can obtain training data information about one or more of the training data instances. The training data information obtained at each iteration can include, for example, the content of the training data instances themselves and/or metadata associated with these training data instances. As examples, the training data instances might be textual documents, images, and/or any other form of data that is used for training the machine-learned model. Example metadata about a training data instance can include a time at which the training data instance was created or modified, information about the subject matter of the training data instance, a geographic location at which the training data instance was created or modified, a domain or a context in which the training data instance was created or modified, etc. Additional examples of metadata can include tags or labels indicative of subject matter contained in or related to the training data instance and/or information indicative of a data source from which the training data instance can be accessed. Yet further examples of metadata for a training data instance can include a compression ratio of the training data instance, other heuristic quality signals, and/or other features of the training data.

The computing system can process the obtained training data information using a machine-learned data rating model to generate respective training data scores for one or more training data instances. Each training data score can indicate a predicted quality or usefulness of the training data instance (e.g., with respect to training a particular model to perform a particular task). Thus, the computing system can use the data rating model to evaluate each data instance based on its potential utility for training purposes. For instance, the data rating model might analyze text complexity, relevance to the task, and/or uniqueness of information in the context of training data instances. The output of this process is a set of scores that quantitatively reflect the estimated value of each data instance for the training of a subject machine-learned model (e.g., the model to be trained using the training data instance). These scores can then guide the selection of the most beneficial data instances for inclusion in training dataset(s), as described further herein.

More particularly, the machine-learned data rating model can be distinguished from the subject machine-learned model. The data rating model is specifically designed to assess the quality or relevance of individual data instances within the training corpus. In contrast, the subject machine-learned model is the model that is being trained to perform a specific task (e.g., language modeling, image recognition, etc.). In general, one goal is to optimize the performance of the subject machine-learned model. It learns from the selected subset of training data. Thus, the data rating model guides the selection of this subset, while the subject machine-learned model benefits from improved training efficiency and performance.

The machine-learned data rating model can include a deep neural network, e.g., a transformer-based neural network, or another type of machine-learned model. The machine-learned data rating model can be configured to receive a training data instance as input and, in response, output a training data score for the training data instance. In some implementations, the machine-learned data rating model can receive various types of information (e.g., one or more values for each of a plurality of features) as input. In these implementations, the machine-learned data rating model can output a training data score for the training data instance based on the received information.

In some implementations, the processing of the training data information with the machine-learned data rating model to generate training data scores can include conditioning the data rating model on model state data descriptive of the state of the subject machine-learned model. Example representations of model state include features such as losses on training points, best possible case of losses (e.g., as compared to a pre-trained model), or other representations of inner model state (e.g., including model parameter values, loss values or loss curves, loss gradient values, loss velocity, etc.). This conditioning allows the data rating model to adapt its evaluations based on the current capabilities and performance characteristics of the subject model. For example, if the subject model is currently performing poorly as a result of training on certain types of data, the data rating model can be adjusted to lower the scores for similar data types in future training cycles. Conversely, data types that lead to better performance in the subject model might receive higher scores. This dynamic adjustment process helps in continuously optimizing the training data selection to align with the evolving state of the machine-learned model, potentially leading to more efficient and effective training outcomes.

In some implementations, the processing of the training data information with the machine-learned data rating model to generate training data scores can include conditioning the data rating model on information about the downstream task that the subject machine-learned model is intended to perform. This allows the data rating model to prioritize data relevant to the specific objectives of the downstream task. Conversely, data less pertinent to the downstream task might receive lower scores.

After generating the training data scores, the computing system can select a subset of training data instances from the corpus of training data instances based on or according to the one or more training data scores generated previously. For example, this selection process can include identifying and choosing data instances that have higher scores. The selection process can operate such that data instances deemed more valuable for training are more likely to be included in the training dataset, thereby potentially enhancing the efficiency and effectiveness of the machine learning model’s training process.

In some implementations, the process of selecting a subset of training data instances from the corpus can be carried out by probabilistically sampling each training data instance. This sampling can be conducted by the computing system with a probability that corresponds to its assigned training data score. To provide an example, if data instance ‘A’ has a score of 0.8 and data instance ‘B’ has a score of 0.2, then data instance ‘A’ is four times more likely to be selected for inclusion in the training subset. In some implementations, to implement this, the scores are normalized to sum to 1, creating a probability distribution over the training data, and any random sampling method that samples from a discrete distribution can be employed. Thus, high-quality data, as determined by the data rating model, is emphasized during the training process, but all data still has a chance of being included. Other sampling techniques can also be used.

In some implementations, the computing system can train the subject machine-learned model using the selected subset of training data that has been identified based on their respective scores. For example, this training process could involve feeding the selected subset of training data instances into the model and adjusting the model’s parameters to minimize error rates on the selected subset of training data instances. The subject machine-learned model can include any suitable type of machine-learned model. Example subject machine-learned models include foundation models such as large language models, image models such as image recognition models, and speech models.

After or during the training phase, the computing system can evaluate the performance of the subject machine-learned model using various performance metrics. This evaluation can include assessing the model’s accuracy, precision, recall, perplexity, and/or other relevant metrics against a validation dataset that was not used during the training phase.

Thus, in some implementations, the evaluation of the model performance data for the subject machine-learned model can involve assessing one or more performance metrics relative to a validation dataset. This evaluation can be conducted before and/or after the model has fully converged during its training on the selected subset of training data. For example, metrics such as accuracy, loss, precision, recall, or F1 score might be computed to gauge the model’s effectiveness in handling unseen data represented by the validation dataset. This early evaluation allows for a timely understanding of the model’s performance, enabling adjustments to the training process or parameters before full convergence (e.g., which may facilitate faster training and/or a reduced consumption of computational resources).

After evaluating the performance of the subject machine-learned model, the computing system can update the machine-learned data rating model based at least in part on the model performance data obtained from the evaluation of the subject machine-learned model. This updating process can include adjusting, modifying, or otherwise changing parameters of the data rating model to enhance its accuracy in predicting the usefulness of training data instances for future training cycles. For example, if the performance data indicates that certain types of data consistently lead to better model performance, the data rating model’s parameters can be tuned to assign higher scores to similar types of data in subsequent iterations.

In some implementations, the updating of the machine-learned data rating model based on the model performance data can involve performing a meta-gradient optimization technique by the computing system. This technique adjusts the parameters of the data rating model in a way that aims to minimize a meta-optimization loss function, which is reflective of the model’s performance. For example, if the model performance data indicates discrepancies in predictions, the meta-gradient optimization can iteratively adjust the data rating model’s parameters to reduce these discrepancies over time.

As one example, let θ represent the parameters of the data rating model and φ represent the parameters of the subject machine-learned model. The data rating model uses θ to assign weights to training data instances. A subset of training data is then selected based on these weights and used to train the subject machine-learned model, resulting in updated parameters φ’. An example meta-objective function, L(φ’(θ)) can measure the performance of the subject machine-learned model with parameters φ’, which are a function of the data rating model parameters θ. The gradient of L with respect to θ, ∇θL(φ’(θ)), can then be computed using techniques such as backpropagation through the training process or approximations thereof. The parameters θ of the data rating model can then be updated using a gradient-based optimization algorithm (e.g., Adam, SGD) to minimize the meta-objective function.

In particular, in some implementations, to update the machine-learned data rating model, backpropagation can be extended through the entire training process of the subject machine-learned model. Specifically, for each data point selected based on the data rating model’s assigned weights, the gradient of the loss incurred by the subject machine-learned model is computed with respect to the subject model’s parameters. Then, these gradients are propagated backward through the subject model’s architecture and further through the data selection process determined by the data rating model. This allows for the computation of a gradient of a meta-objective (e.g., validation loss of the subject machine-learned model) with respect to the parameters of the data rating model.

In some implementations, the meta-gradient optimization technique used for updating the machine-learned data rating model utilizes the same loss function as that used when training the subject machine-learned model on the selected subset of training data. This approach ensures consistency in the evaluation criteria across different stages of model training and optimization. For instance, if the loss function is based on mean squared error during model training, the same function will guide the meta-optimization. This increases the likelihood that improvements in the data rating model directly correlate with potential improvements in the subject model’s training.

In some implementations, the computing system can update the machine-learned data rating model by performing an evolutionary learning technique. This technique can include using principles such as mutation, crossover, and selection to evolve the model parameters over generations. For example, parameter sets that result in better performance can be “selected” to reproduce, while less effective ones are discarded. This method can be particularly useful for exploring a wide parameter space and potentially discovering novel solutions that traditional optimization methods might miss.

Thus, in some implementations, a population of candidate data rating models is maintained, each with a different set of parameter values. The fitness of each candidate model is evaluated based on the performance of the subject machine-learned model when trained on data selected according to the candidate data rating model’s weights. The performance of the subject machine-learned model (e.g., validation loss, accuracy) then serves as the fitness score for the corresponding candidate data rating model. Candidate models with higher fitness scores are more likely to be selected for reproduction, where their parameters are combined (crossover) and potentially mutated to create new candidate models for the next generation. Over multiple generations, the population evolves towards data rating models that induce training data distributions that lead to improved subject model performance.

In some implementations, the computing system can update the machine-learned data rating model by performing evolutionary strategies techniques or other so-called “black box optimization algorithms”. In some example evolutionary strategies techniques, the computing system can approximate a gradient of the data rating model with respect to a meta-objective. For example, as described above, the meta-objective can be or can be a function of the performance of the subject model (e.g., the performance of the subject model relative to a validation dataset). The data rating model can then be iteratively updated according to the approximated gradient.

Specifically, some evolutionary strategies techniques can include the following steps: sampling multiple perturbations (e.g., random perturbations) to the parameter values of the data rating model; evaluating a change in the meta-objective (e.g., a reduction in validation loss for the subject model) resulting from each perturbation; and forming a numerical meta-gradient approximation based on (e.g., as a combination of) the sampled perturbations. For example, forming the numerical meta-gradient approximation can include determining a linear combination of the sampled perturbations weighted in proportion to their change or impact upon the meta-gradient (e.g., each perturbation weighted in proportion to their validation loss reduction).

Stated more generally, the computing system can evaluate random perturbations of the data rating model to assess whether such perturbations would improve the meta-objective. The parameters of the data rating model can then be adjusted in the direction of perturbations that result in improved performance and adjusted away from perturbations that result in decreased performance. Further example details regarding example evolutionary strategies are described in Wierstra et. al., Natural Evolution Strategies, Journal of Machine Learning Research 15 (2014) 949-980; and Salimans et. al., Evolution Strategies as a Scalable Alternative to Reinforcement Learning, arXiv:1703.03864v2.

In some implementations, the computing system can perform a reinforcement learning technique to update the one or more values of the parameters of the machine-learned data rating model based on the model performance data. For example, the data rating model can be considered an agent that receives rewards (e.g., generated by a reward model or other reward function) based on the efficacy of its ratings in improving the subject model’s performance. For example, if a particular set of parameter adjustments results in a significant improvement in model accuracy, the data rating model receives a positive reward, encouraging the model to favor similar adjustments in the future.

Thus, the data rating model can act as an agent that interacts with the training environment of the subject machine-learned model. The state of the environment could include information about the current training data distribution, the performance of the subject machine-learned model, and/or the current training iteration. The agent (data rating model) takes actions by adjusting the scores assigned to different training data instances. The reward signal can be based on the improvement in performance of the subject machine-learned model after being trained on the data selected according to the agent’s actions. For example, the reward could be proportional to the reduction in validation loss or the increase in accuracy of the subject machine-learned model. The agent can learn a policy (e.g., a mapping from states to actions) that maximizes the expected cumulative reward over time. This can be achieved using reinforcement learning algorithms such as Q-learning, policy gradient methods, and/or other techniques.

In some implementations, these various techniques for updating the machine-learned data rating model—meta-gradient optimization, evolutionary learning, evolutionary strategies, and reinforcement learning—can be employed in isolation or in combination.

In some implementations, during the plurality of meta-optimization iterations, the computing system can insert one or more newly-generated training instances into the corpus of training instances. These new training instances can contain inputs and/or outputs generated by the subject machine-learned model during one of the meta-optimization iterations. For example, if the subject model generates novel textual content or predictions during training, these outputs can be formatted as new training instances and added back into the training corpus. This process of dynamically enriching the training corpus with fresh data that reflects the current learning state and capabilities of the model can help in continuously refining the model’s performance. It introduces a feedback loop where the model not only learns from but also contributes to its training environment which accelerates the learning process.

In some implementations, the method can further include outputting an optimized subset of training data instances that have been selected based on a final set of training data scores generated by a final version of the machine-learned data rating model, for example after completing the plurality of meta-optimization iterations. This optimized subset represents the most beneficial training data instances as determined through the iterative refinement process of the data rating model. For example, this subset can be used to train a final version of a machine-learned model (e.g., the subject model) or to enhance the training of other related model(s). By outputting this optimized subset, the system ultimately provides a curated set of data that maximizes training effectiveness, based on iterative evaluations conducted throughout the meta-optimization process.

In some implementations, the method can further include training a target machine-learned model using the optimized subset of training data instances that were previously selected. This target model can either be the same as the subject machine-learned model that was used during the optimization process, or it can be a different model. For example, the target model may be a different model that has more parameters and/or requires additional processing resources. For instance, after optimizing the training data selection with a smaller, less resource-intensive model, the optimized data subset could then be used to train a larger, more complex model that aims to achieve higher performance on more demanding tasks. This approach allows for efficient use of computational resources during the meta-optimization phase, while still enabling the benefits of enhanced training data to be applied to more powerful model(s) in subsequent training efforts.

Some specific, non-limiting examples of implementations in which a relatively smaller model is used as the subject model while a relatively larger model is used as the target model are now described. In some implementations, the target model may have about or at least 2, 5, 10, or 100 times as many parameters as compared to the subject model. As one example, the subject model may have approximately 150 million parameters, while the target model may have approximately 1.6 billion parameters. In another example, the subject model may be a model (e.g., language model) with 27 million parameters. In yet another example, the target model may be a model (e.g., language model) with up to and including 2 billion parameters, while the subject model can be a model (e.g., language model) with approximately 50 million parameters. Similarly, the machine-learned data rating model can be the same size as or a different size from the subject model and/or the target model. For example, the data rating model can be a smaller model as compared to the target model. For example, the data rating model can be a different instantiation of the subject model.

Example technical effects of the proposed technology include improvements to several aspects of machine learning systems, particularly in terms of efficiency and effectiveness of training. By selectively choosing high-quality data instances based on calculated scores, the system minimizes computational waste, optimizes memory usage, and speeds up the training process, thereby reducing the consumption of processor cycles, computer memory, and/or network bandwidth. This selective approach also enhances the performance of the trained models since they are less likely to learn from noisy or irrelevant data. The ability to achieve the same or improved model performance with reduced computational expenditure represents an improvement to the computing system itself.

Additionally, the technology’s capability to insert newly-generated training instances into the training corpus, based on outputs from the subject machine-learned model, introduces a novel method of enriching training data in a context-aware manner. This feature utilizes the outputs of the machine learning process itself to generate additional data points that can be used for further training. Further, the meta-optimization process ensures that only newly-generated training instances that ultimately improve model performance are primarily used to train the model. This self-reinforcing mechanism is a technical strategy that leverages the computational properties of the model to enhance its own training process.

Various example implementations are described herein with respect to the accompanying Figures.

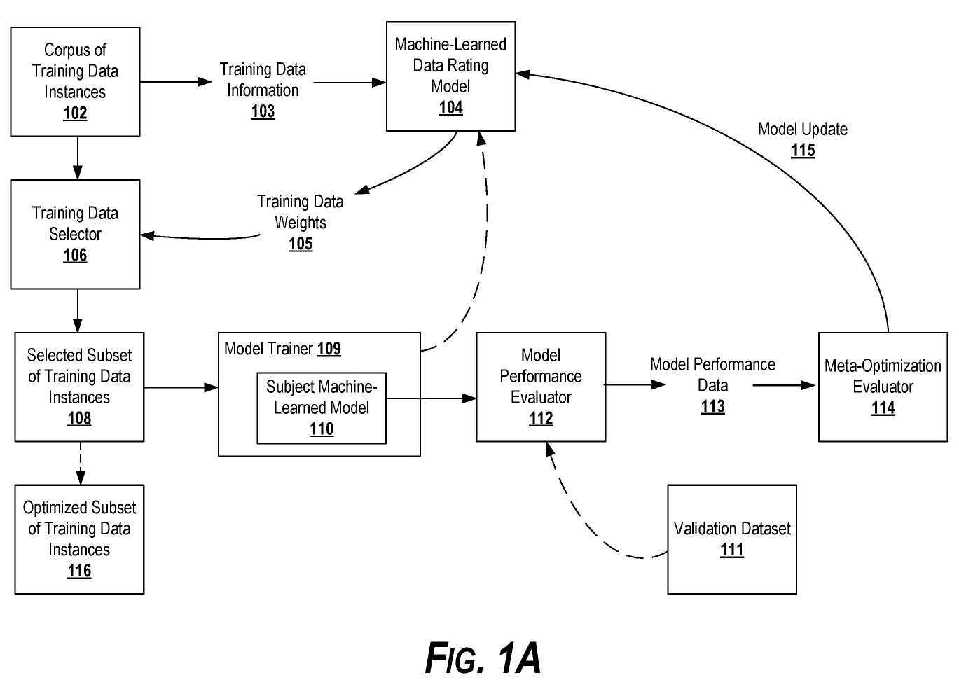

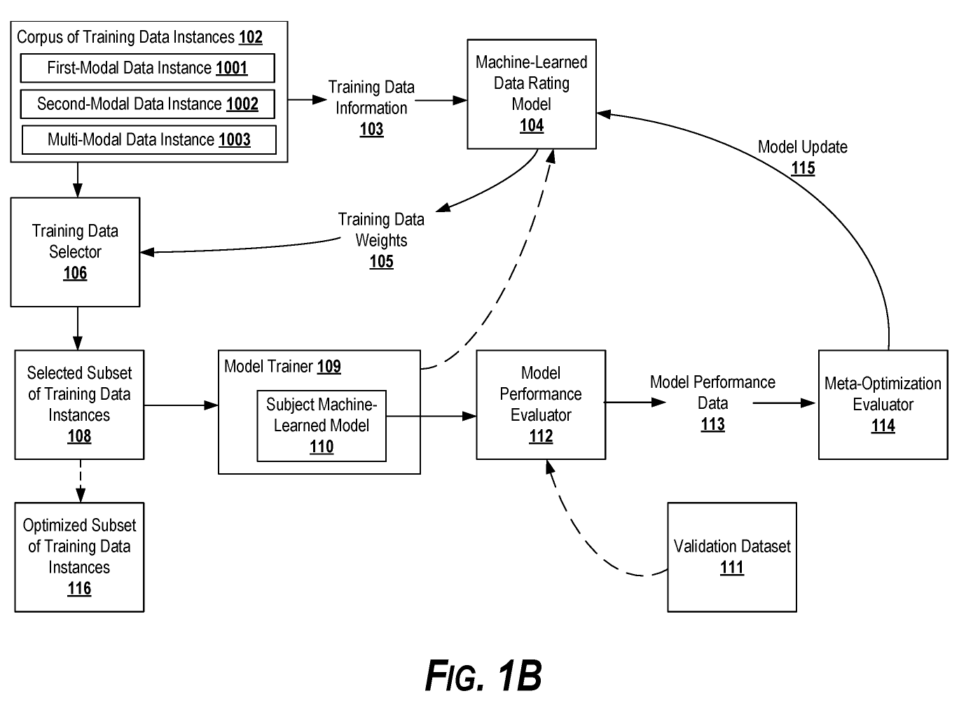

FIG. 1A illustrates a system for optimizing training data selection for machine-learned models. A corpus of training data instances 102 serves as the initial source of data for the system. This corpus 102 can include a variety of data types, such as textual documents, images, or sensor data, which are intended for use in training machine learning models. For instance, the textual documents could be sourced from online articles, books, or databases, while images might be collected from digital archives or real-time feeds from cameras. In one implementation, sensor data could be obtained from IoT devices deployed in various environments, collecting data like temperature, motion, or other measurable parameters. For example, if the subject machine-learned model is a large language model, the corpus 102 can include a large collection of web pages, books, and articles. As another example, if the subject machine-learned model is an image recognition model, the corpus 102 can include a large dataset of labeled images. This diversity allows for robust model training across different domains and applications. As yet another example, if the subject machine-learned model is a multi-modal model, then the corpus 102 can include training examples that include data from multiple different modalities. For example, a multi-modal corpus 102 can include training examples that correspond to a first modality (e.g., text), training examples that correspond to a second, different modality (e.g., imagery, audio, time-series data, and/or other modalities), and/or training examples that simultaneously correspond to multiple different modalities (e.g., training examples that include both text and image data, and/or other combinations of modalities).

Training data information 103 is derived from the corpus of training data instances 102. This information can be extracted as raw data or as metadata that describes the characteristics of each data instance. Examples of metadata include the source of data, date of creation, and/or labels provided by human annotators. To illustrate, metadata extraction can be performed using automated scripts that parse data files and extract relevant information such as the file creation date or the geographical location associated with the data. In another implementation, labels might be generated through crowd-sourced platforms where human annotators provide insights or categorizations based on the content of the data.

A machine-learned data rating model 104 receives the training data information 103 and processes it to assess the quality of each data instance. The output of this model is a set of training data scores 105, which quantitatively represent the estimated utility of each data instance for the purpose of training a machine-learned model. For instance, the data rating model 104 can include algorithms such as neural networks or decision trees that analyze features extracted from the training data information and assign scores based on their predicted relevance to the training goals. In one implementation, the model could use natural language processing techniques to analyze textual content and determine its complexity or relevance to a specific training objective.

In some implementations, the data rating model 104 can be implemented as a feedforward neural network with an input layer of size n, followed by several hidden layers (e.g., 2-3 layers) with ReLU activation functions, and/or an output layer with a sigmoid activation function to produce a weight between 0 and 1. In some implementations, the model 104 can be initially trained on a proxy task such as predicting document quality scores assigned by a heuristic-based method.

The data rating model 104 may consider factors such as the relevance of the data instance to the training task, the quality of the data, and the diversity of the data relative to the current training distribution. For instance, the data rating model 104 could learn to assign higher weights to data instances that are similar to those on which the subject model is currently struggling or to data instances that cover underrepresented areas of the input space.

The training data selector 106 utilizes the training data scores 105 to select a subset of training data instances 108 from the corpus of training data instances 102. The selection process can be based on criteria such as the highest scores or a threshold value that determines which instances are likely to yield the most effective training outcomes. To illustrate, a selection algorithm could prioritize data instances with scores above a certain percentile, ensuring that only the most relevant data is used for training. In another implementation, the selection process could be dynamically adjusted based on ongoing training results to continuously refine the criteria for selecting data.

In some implementations, the threshold for selecting data instances can be dynamically adjusted based on the distribution of weights, such as selecting instances above the median weight or selecting a fixed percentage (e.g., 20%) of the instances with the highest weights, and the minimum number of instances selected per iteration can be set to ensure sufficient training data (e.g., 1000 instances).

In some implementations, the training data selector 106 implements a sampling strategy based on the training data weights 105. One possible sampling strategy is to select data instances with probability proportional to their weights. This would ensure that high-quality data instances are more likely to be included in the selected subset 108. However, other sampling strategies could also be used, such as selecting a fixed number of the highest-weighted instances or using a more sophisticated sampling algorithm that takes into account factors such as data diversity and batch size.

The model trainer 109 takes the selected subset of training data instances 108 and uses them to train the subject machine-learned model 110. The subject machine-learned model 110 can be any type of machine learning model, such as a neural network, decision tree, or support vector machine, that is being optimized for performance. For instance, the training process can include feeding the selected data instances into the model and adjusting model parameters using algorithms like stochastic gradient descent or backpropagation. In some implementations, the training could be performed on specialized hardware such as GPUs or TPUs to accelerate the computations.

During or after the training process, the model performance evaluator 112 assesses the performance of the subject machine-learned model 110 with respect to various metrics such as accuracy, precision, and recall. The performance data is shown as model performance data 113. For example, the evaluation might involve running the trained model against a separate validation dataset and calculating performance metrics to gauge its accuracy and reliability. In another implementation, metrics such as the area under the ROC curve or F1 score might be used for models requiring balanced precision and recall.

The validation dataset 111 is used to provide an independent measure of model performance. It is typically a set of data instances that were not used during the training phase and serves to validate the generalizability and effectiveness of the subject machine-learned model 110. For example, this dataset could be sourced from a different domain or collected using different methods to ensure that the model performs well across diverse conditions. In another implementation, the validation dataset might be periodically updated to reflect new emerging data trends and challenges. Because, in some implementations, performance of the subject model 110 on the validation dataset 111 is primary driver of system behavior, curation of the validation dataset 111 represents an easily controllable mechanism to control behavior of the meta-optimization system. Stated differently, the developer team attempting to optimize the distribution of training data can simply tweak the distribution of data in the validation dataset 111 and then run the meta-optimization system to identify the optimal set of training data for model performance relative to the task reflected by the validation dataset 111.

The model performance data 113 is then processed by the meta-optimization evaluator 114, which analyzes the data to determine how the training process can be further optimized. This evaluation can involve adjusting or otherwise changing the parameters of the machine-learned data rating model 104 to improve future iterations of training data selection. For instance, the meta-optimization process could use techniques like gradient descent to fine-tune the data rating model 104 based on the observed impacts of selected training data on model performance. As another example, evolutionary algorithms and/or various black box optimization algorithms such as evolutionary strategies could be used to explore various configurations of the data rating model to identify the most effective settings.

In some implementations, the meta-optimization evaluator 114 calculates a meta-optimization loss function that reflects the overall goal of the meta-optimization process. This loss function may take into account factors such as the validation loss of the subject model, the amount of training data used, and/or the training time. For example, the meta-optimization loss function could be designed to penalize data rating models that select too much low-quality data or that require too much training time to achieve a desired level of performance.

A model update 115 may occur based on the insights gained from the meta-optimization evaluator 114. This update can involve modifications to the machine-learned data rating model 104, which in turn affects subsequent cycles of training data selection and model training. For instance, the update process can include modifying parameters of the model (e.g., according to a gradient and step size) or generating new mutations of the data rating model.

In some implementations, the process then repeats, with the updated data rating model being used to select a new subset of training data and train the subject model. This iterative process continues for a number of meta-optimization iterations, allowing the data rating model to adapt to the evolving state of the subject model and to learn an optimized training data distribution.

In some implementations, an optimized subset of training data instances 116 can be output and can represent the resulting selection of data instances that have been identified as most beneficial for training after several iterations of optimization. These instances are chosen based on their ability to improve the performance of the subject machine-learned model 110 in a measurable way. For example, this subset might include instances that have been found to contribute to higher accuracy or faster convergence during training. In some implementations, the optimized subset can be dynamically updated (e.g., in an online manner) in real-time as new data becomes available and is evaluated by the system.

For example, consider a scenario where the subject machine-learned model is a large language model being trained on a corpus of text documents. Initially, the data rating model might assign similar weights to all documents in the corpus. However, after training the subject model on a subset of these documents, the model performance evaluator might find that the model is struggling to understand a particular type of text, such as scientific articles. The meta-optimization evaluator would then calculate a loss that reflects this poor performance, and the model update would adjust the parameters of the data rating model so that it assigns higher weights to scientific articles. In subsequent iterations, the subject model would be trained on a subset of data that includes a higher proportion of scientific articles, which would improve its ability to understand this domain of text.

Each of the training data selector 106, model trainer 109, model performance evaluator 112, and meta-optimization evaluator 114 can be implemented using hardware, software, firmware, or some combination thereof. In some cases, each of the training data selector 106, model trainer 109, model performance evaluator 112, and meta-optimization evaluator 114 can include or be implemented using one or more processors that load computer-executable instructions from a computer-readable memory and then execute the computer-executable instructions.

FIG. 1B depicts an example implementation in which an example computing system is applied to optimize a distribution of training data that includes training data instances associated with multiple different modalities. Similar to the example system shown in FIG. 1A, the example system shown in FIG. 1B can include a corpus of training data instances 102. More specifically, however, in the example shown in FIG. 1B, the corpus of training data instances can include training data instances associated with multiple different modalities.

As one example, the corpus 102 can include a first-modal data instance 1001 that is associated with a first data modality. For example, the first-modal data instance 1001 could be a high-resolution image or video. As another example, the corpus 102 can include a second-modal data instance 1002 that is associated with a second data modality. For example, the second-modal data instance 1002 could be textual data such as textual queries and responses. As yet another example, the corpus 102 can include a multi-modal data instance 1003 that includes data that corresponds to multiple different modalities. For example, the multi-modal data instance 1003 could include both a video (e.g., a series of image frames, potentially with corresponding audio content) that is temporally aligned with other forms of sensor data (e.g., RADAR data, LIDAR data, audio data, etc.). The instances 1001, 1002, 1003 can correspond to many different modalities (e.g., text, audio, time-series data, image data, arbitrary sensor data, etc.) and/or various combinations thereof.

Consider, with reference to FIG. 1B, an example scenario where the subject machine-learned model is a model that is tasked with selecting an output action for a robotic device in an environment (e.g., a robotic device that autonomously controls its motion in a real-world environment). Initially, the data rating model might assign similar weights to all training data instances in the corpus. However, after training the subject model on a subset of these instances, the model performance evaluator might find that the model is struggling to choose the correct robotic action in situations in which the robotic device encounters certain conditions (e.g., snowy environments). The meta-optimization evaluator would then calculate a loss that reflects this poor performance, and the model update would adjust the parameters of the data rating model so that it assigns higher weights to training data instances that depict or otherwise correspond to the particular conditions (e.g., snowy environments). In subsequent iterations, the subject model would be trained on a subset of data that includes a higher proportion of training data instances that demonstrate the particular conditions (e.g., videos or other sensor data captured during snowy conditions), which would improve its ability to understand (e.g., choose the correct robotic control action for) this particular environmental scenario.

Further, while the above-described example relates to certain environmental conditions, the same concept can be applied to automatically modify the distribution of selected training data instances so that the subject model is provided with training data instances corresponding to certain modalities with which the subject model is currently struggling. For example, if a subject model demonstrates strong performance on validation tasks relating to interpretation of audio data but poor performance on validation tasks relating to interpretation of LIDAR data, then the disclosed optimization system may operate over time to increase the proportion of training data instances that are selected from the corpus which include LIDAR training data.

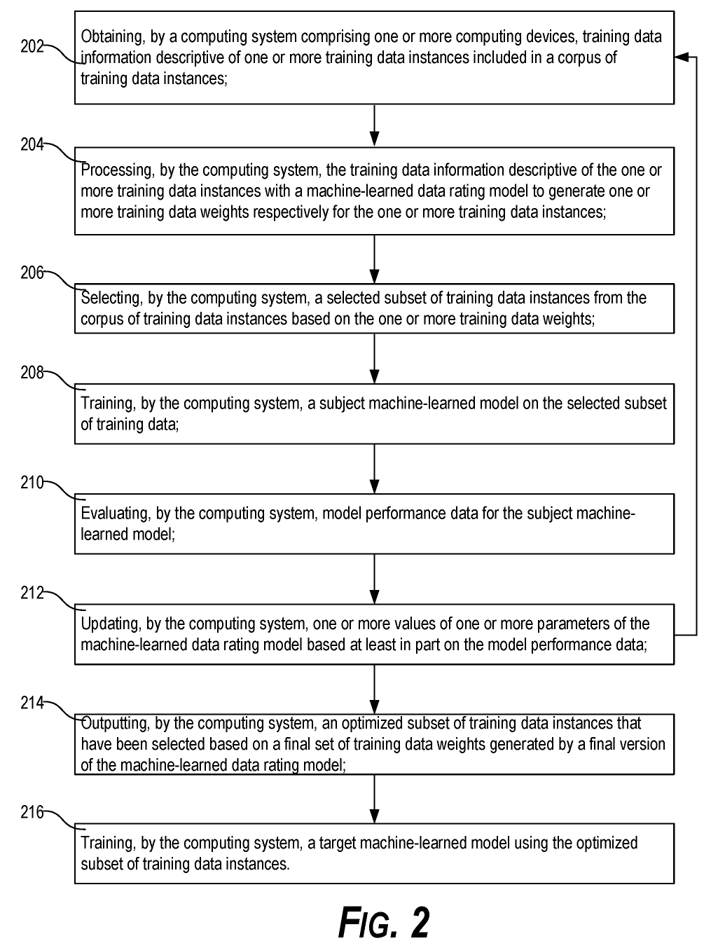

FIG. 2 presents a flowchart diagram illustrating an example method for optimizing the selection and use of training data in machine learning models. One or more portion(s) of the method shown in FIG. 2 can be implemented by a computing system that includes one or more computing devices such as, for example, computing systems described with reference to the other figures. Each respective portion of the method shown in FIG. 2 can be performed by any (or any combination) of one or more computing devices. Moreover, one or more portion(s) of the method shown in FIG. 2 can be implemented on the hardware components of the device(s) described herein, for example, to train one or more systems or models. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of the method shown in FIG. 2 can be performed additionally, or alternatively, by other systems.

Step 202 can include obtaining, by the computing system, training data information descriptive of one or more training data instances included in a corpus of training data instances. This step can include extracting both raw data and/or metadata from various sources such as databases, online content, or sensor data. The metadata might detail the origin, timestamp, and other relevant characteristics of each data instance, facilitating a comprehensive understanding of the training dataset.

Step 204 can include processing, by the computing system, the training data information with a machine-learned data rating model to generate one or more training data scores respectively for the one or more training data instances. This machine-learned data rating model evaluates each data instance to assign scores that reflect their estimated utility for training a subject model. The criteria could include factors like relevance to the training objective, data quality, and/or uniqueness.

Step 206 can include selecting, by the computing system, a selected subset of training data instances from the corpus of training data instances based on the one or more training data scores. This selection is typically driven by choosing data instances with the highest scores, ensuring that the most potentially valuable data is used for training the model. In some implementations, this step can employ algorithms that prioritize data diversity and coverage to avoid biases and overfitting.

Step 208 can include training, by the computing system, a subject machine-learned model on the selected subset of training data. This can include applying machine learning algorithms to adjust the model’s parameters. The training process may utilize various optimization techniques like gradient descent to minimize error rates and improve the model’s accuracy.

Step 210 can include evaluating, by the computing system, model performance data for the subject machine-learned model after or during training on the selected subset of training data. This evaluation can assess how well the subject model performs on a set of validation data that was not used during the training phase, using metrics such as accuracy, precision, recall, and F1 score.

Step 212 can include updating, by the computing system, the machine-learned data rating model based at least in part on the model performance data. This update aims to refine the data rating model based on its effectiveness in selecting training data that leads to high-performing machine-learned models. The update can be guided by techniques such as meta-gradient optimization, reinforcement learning, evolutionary techniques, and/or evolutionary strategies, which adjust the model parameters to maximize performance outcomes.

The arrow from step 212 back to step 202 indicates that these steps can be performed iteratively, e.g., until some stop condition is met, such as a number of iterations meeting a predefined iteration, a learning momentum or gain falling below a threshold momentum or gain, and/or other stop conditions.

Step 214 can include outputting, by the computing system, an optimized subset of training data instances that have been selected based on a final set of training data scores generated by a final version of the machine-learned data rating model. This subset represents the most effective data for training as determined through iterative refinement and is intended for use in critical training operations.

Finally, step 216 includes training, by the computing system, a target machine-learned model using the optimized subset of training data instances. In some cases, this target model may be a more complex or different type of model than the subject machine-learned model used in earlier steps and is trained to achieve optimal performance for specific applications.

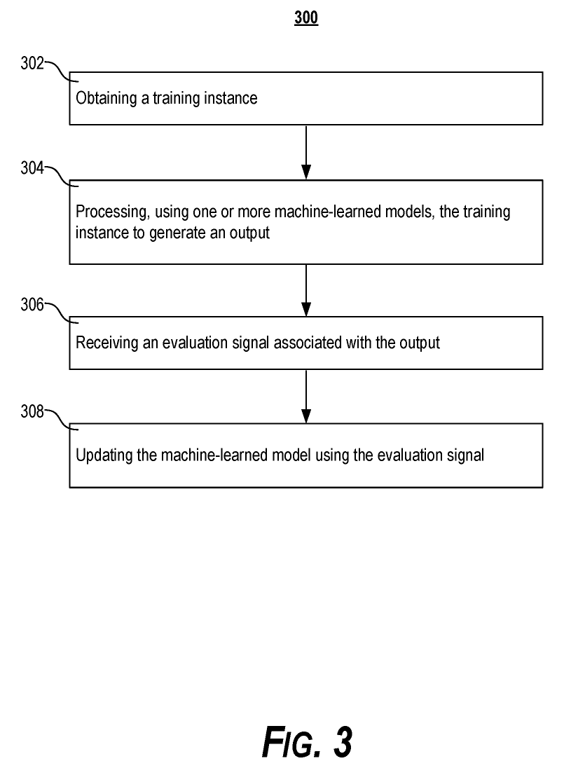

FIG. 3 depicts a flowchart of a method 300 for training one or more machine-learned models according to aspects of the present disclosure. One or more portion(s) of example method 300 can be implemented by a computing system that includes one or more computing devices such as, for example, computing systems described with reference to the other figures. Each respective portion of example method 300 can be performed by any (or any combination) of one or more computing devices. Moreover, one or more portion(s) of example method 300 can be implemented on the hardware components of the device(s) described herein, for example, to train one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of example method 300 can be performed additionally, or alternatively, by other systems.

At 302, example method 300 can include obtaining a training instance. A set of training data can include a plurality of training instances divided between multiple datasets (e.g., a training dataset, a validation dataset, or testing dataset). A training instance can be labeled or unlabeled. Although referred to in example method 300 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 304, example method 300 can include processing, using one or more machine-learned models, the training instance to generate an output. The output can be directly obtained from the one or more machine-learned models or can be a downstream result of a chain of processing operations that includes an output of the one or more machine-learned models.

At 306, example method 300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 308, example method 300 can include updating the machine-learned model using the evaluation signal. For example, values for parameters of the machine-learned model(s) can be learned, in some implementations, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 300 can include implementing a number of generalization techniques (e.g., weight decays, dropouts, etc.) to improve the generalization capability of the models being trained.

In some implementations, example method 300 can be implemented for training a machine-learned model from an initialized state to a fully trained state (e.g., when the model exhibits a desired performance profile, such as based on accuracy, precision, recall, etc.).

In some implementations, example method 300 can be implemented for particular stages of a training procedure. For instance, in some implementations, example method 300 can be implemented for pre-training a machine-learned model. Pre-training can include, for instance, large-scale training over potentially noisy data to achieve a broad base of performance levels across a variety of tasks/data types.

In some implementations, example method 300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 300 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 300 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

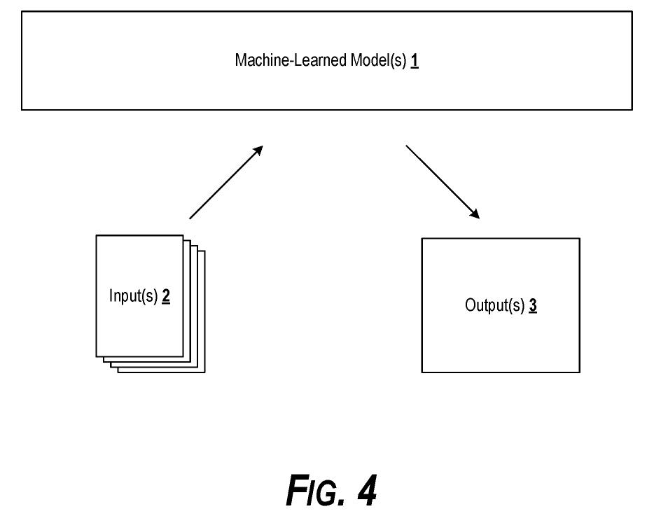

Example tasks that machine-learned models can be trained to perform (e.g., via performance of method 300 in conjunction with the framework shown in FIGS. 1A and 1B) are described in further detail below with respect to FIG. 4 and also other figures. However, as one example, the machine-learned model can be trained to generate navigational commands for robotic devices to circumvent obstacles using data from visual sensors and/or other inputs. Additionally or alternatively, the machine-learned model can be trained to interpret verbal instructions, converting these into specific robotic actions such as retrieving items or providing information.

Other examples relate to code generation and action generation. For example, the machine-learned model can be trained to dynamically modify control algorithms based on environmental feedback or performance metrics. For instance, if a robotic device consistently underperforms in specific scenarios, the model can generate code updates to enhance sensor processing or adapt the robotic device’s decision-making framework.As other examples, the machine-learned model can be applied to tasks such as predictive maintenance, where it can analyze sensor data from machinery to predict failures before they occur. In healthcare, the machine-learned model can assist in diagnostic processes by analyzing medical images and patient data to suggest potential diagnoses. As another example, the machine-learned model can be trained to generate responses to human queries by understanding and processing user input through natural language processing techniques.

FIG. 4 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of any learned component described herein, etc. Although various features, variations, and implementations described below are described with respect to machine-learned model(s) 1, it is to be understood that such features, variations, and implementations are to be understood as described with respect to each of any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer’s central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

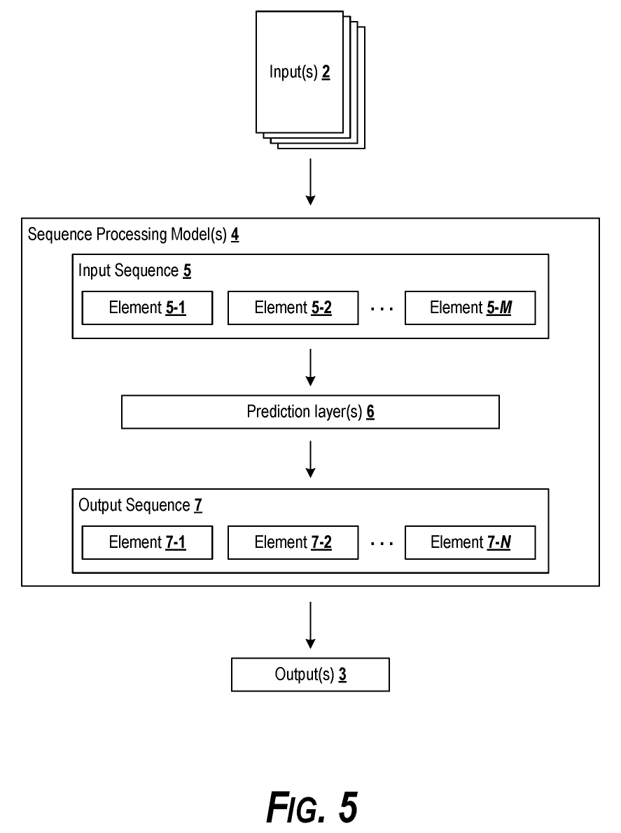

FIG. 5 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google, https://arxiv.org/abs/2403.08295; Gemma 2: Improving Open Language Models at a Practical Size, Google, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google, https://arxiv.org/abs/2407.07726; PaliGemma 2: A Family of Versatile VLMs for Transfer, Google, https://arxiv.org/abs/2412.03555; Flamingo: a Visual Language Model for Few-Shot Learning, Google, https://arxiv.org/abs/2204.14198; PaLI: A Jointly-Scaled Multilingual Language-Image Model, Google, https://arxiv.org/abs/2209.06794.

Sequence processing model(s) 4 can be multimodal. Example multimodal sequence processing models include, for instance, models described in Gemini: A Family of Highly Capable Multimodal Models, Google, https://arxiv.org/abs/2312.11805; Gemini 1.5: Unlocking multimodal understanding across millions of tokens of context, Google, https://arxiv.org/abs/2403.05530.

Other example sequence processing models can operate to generate outputs or receive inputs in specific domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 5 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

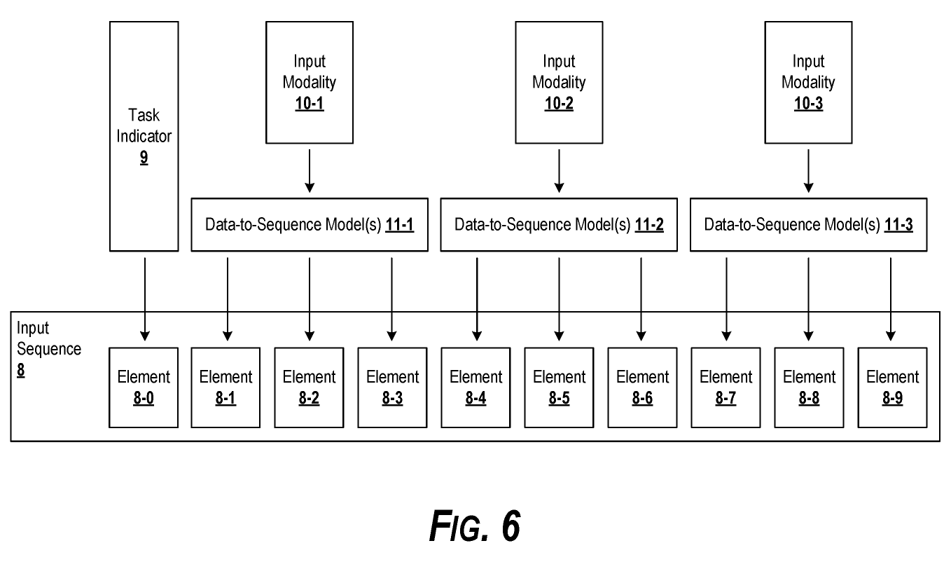

FIG. 6 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

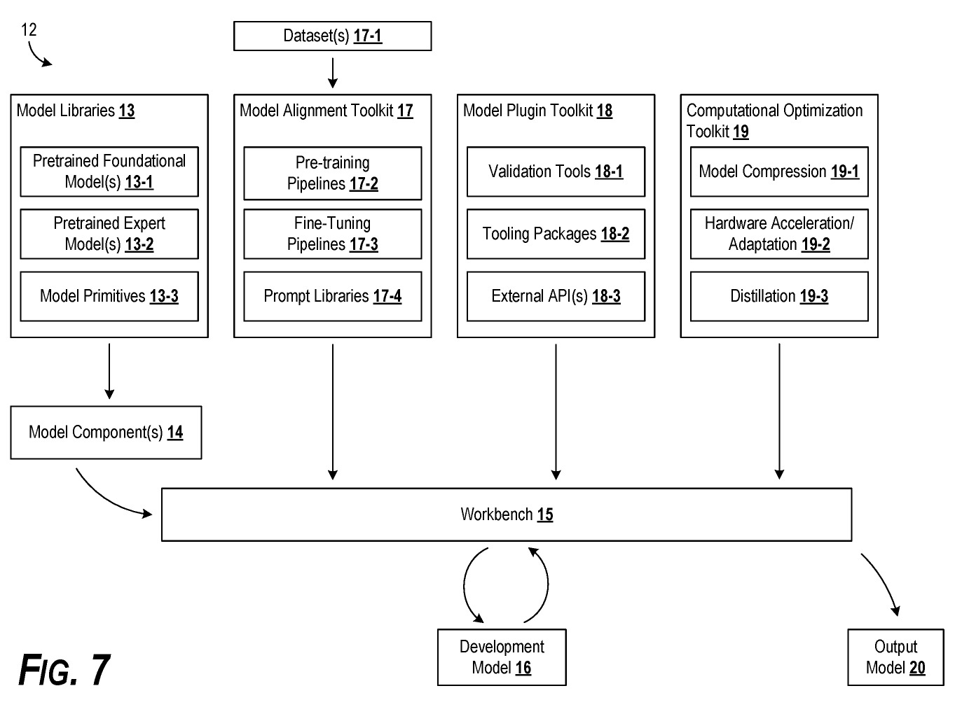

FIG. 7 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

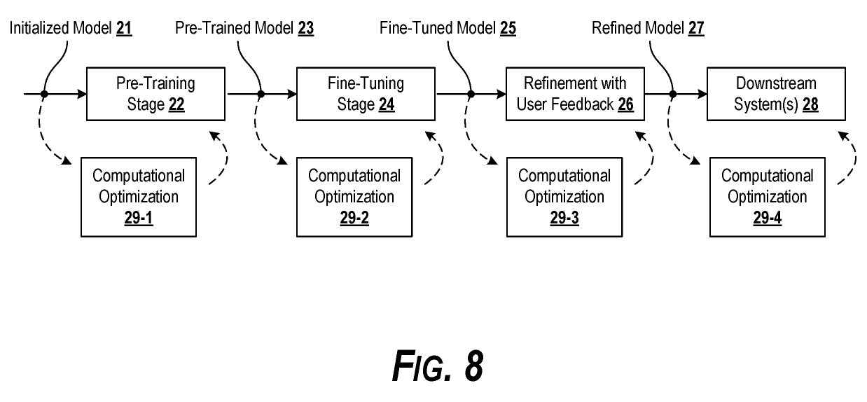

FIG. 8 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

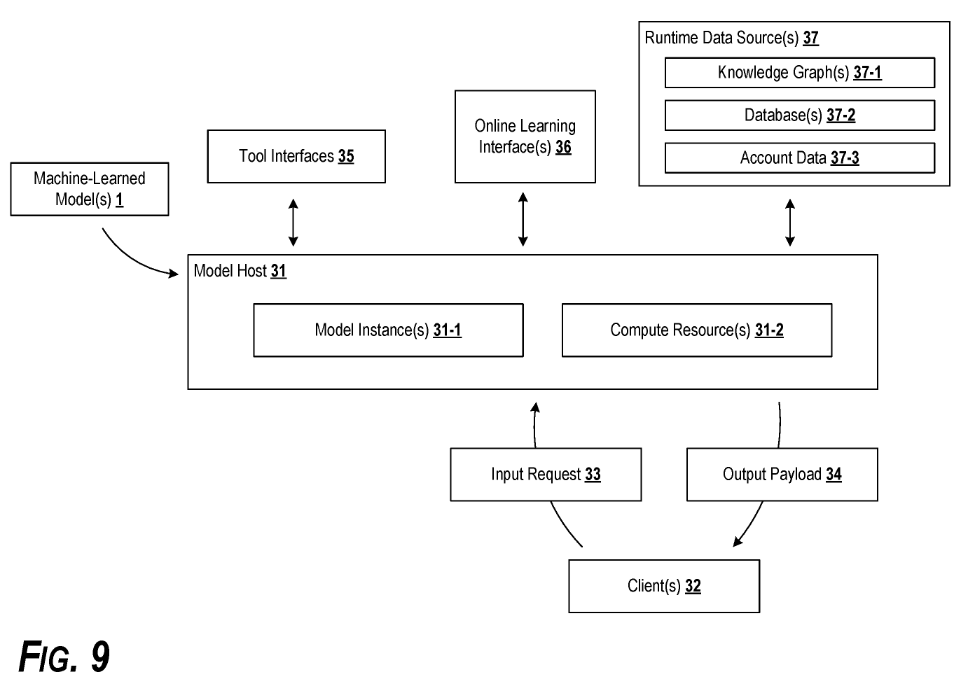

FIG. 9 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

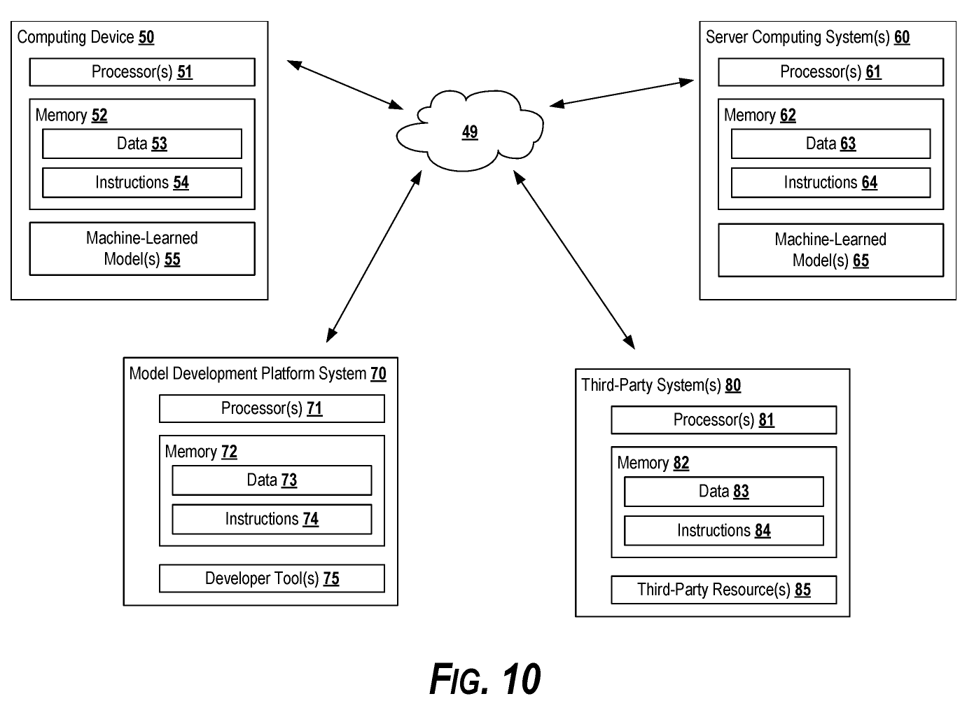

FIG. 10 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 10 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

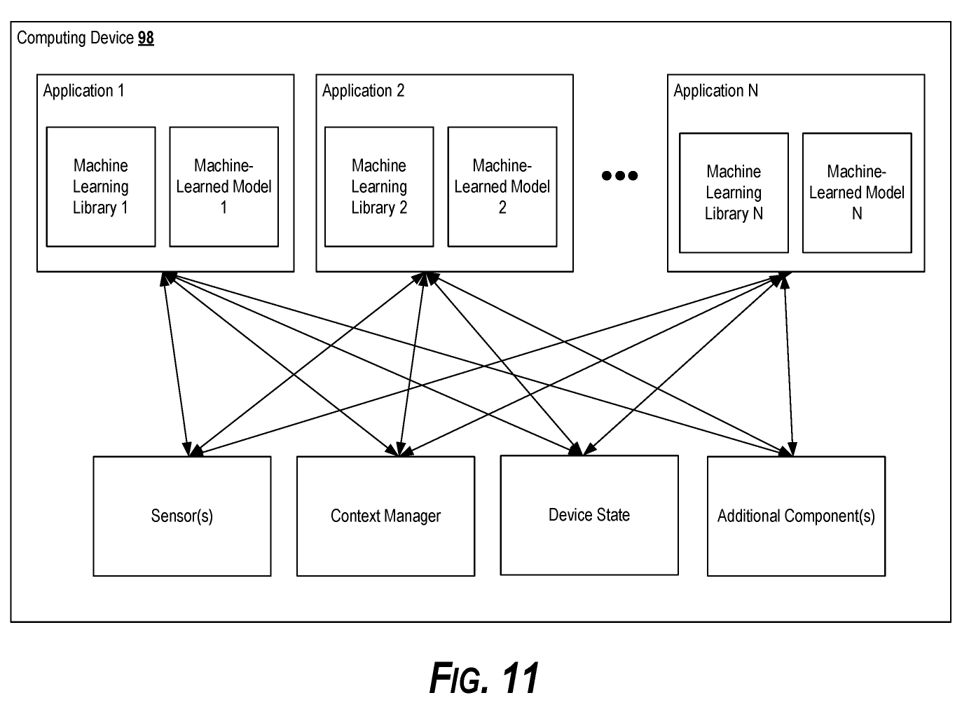

FIG. 11 is a block diagram of an example computing device 98 that performs according to example implementations of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

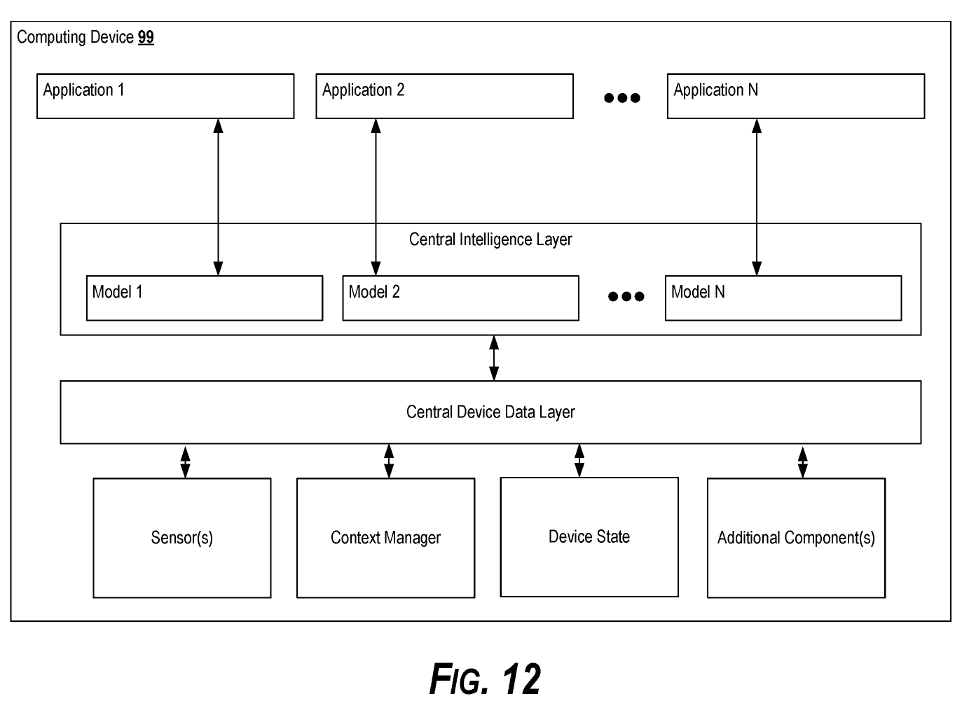

FIG. 12 is a block diagram of an example computing device 99 that performs according to example implementations of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example implementations thereof, each example is provided by way of explanation, not limitation of the disclosure. Those skilled in the art, upon attaining an understanding of the foregoing, can readily produce alterations to, variations of, and equivalents to such implementations. Accordingly, the subject disclosure does not preclude inclusion of such modifications, variations or additions to the present subject matter as would be readily apparent to one of ordinary skill in the art. For instance, features illustrated or described as part of one implementation can be used with another implementation to yield a still further implementation. Thus, it is intended that the present disclosure cover such alterations, variations, and equivalents.

Aspects of the disclosure have been described in terms of illustrative implementations thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
for each of a plurality of meta-optimization iterations:
obtaining, by a computing system comprising one or more computing devices, training data information descriptive of one or more training data instances included in a corpus of training data instances;
processing, by the computing system, the training data information descriptive of the one or more training data instances with a machine-learned data rating model to generate one or more training data scores respectively for the one or more training data instances;
selecting, by the computing system, a selected subset of training data instances from the corpus of training data instances based on the one or more training data scores;
training, by the computing system, a subject machine-learned model on the selected subset of training data;
after or during training the subject machine-learned model on the selected subset of training data, evaluating, by the computing system, model performance data for the subject machine-learned model; and
updating, by the computing system, the machine-learned data rating model based at least in part on the model performance data.

2. The computer-implemented method of claim 1, wherein the training data information comprises the one or more training data instances.

3. The computer-implemented method of claim 1, wherein the training data information comprises metadata associated with the one or more training data instances.

4. The computer-implemented method of claim 1, wherein the corpus of training data instances comprises training data instances having multiple different modalities.

5. The computer-implemented method of claim 1, wherein the corpus of training data instances comprises training data instances having multiple different data sources.

6. The computer-implemented method of claim 1, wherein the corpus of training data instances comprises a mixture of real training data instances and synthetic training data instances.

7. The computer-implemented method of claim 1, wherein selecting, by the computing system, a selected subset of training data instances from the corpus of training data instances based on the one or more training data scores comprises probabilistically sampling, by the computing system, each training data instance from the corpus of training data instances with a probability according to its corresponding training data score.

8. The computer-implemented method of claim 1, wherein processing, by the computing system, the training data information with the machine-learned data rating model to generate the one or more training data scores comprising conditioning, by the computing system, the machine-learned data rating model on model state data descriptive of a model state of the subject machine-learned model.

9. The computer-implemented method of claim 1, wherein the method further comprises:
inserting, by the computing system into the corpus of training instances and during the plurality of meta-optimization iterations, one or more newly-generated training instances that contain outputs generated by the subject machine-learned model during one of the meta-optimization iterations.

10. The computer-implemented method of claim 1, further comprising, after the plurality of meta-optimization iterations:
outputting, by the computing system, an optimized subset of training data instances that have been selected based on a final set of training data scores generated by a final version of the machine-learned data rating model.

11. The computer-implemented method of claim 10, further comprising:
training, by the computing system, a target machine-learned model using the optimized subset of training data instances.

12. The computer-implemented method of claim 11, wherein the target machine-learned model is the subject machine-learned model.

13. The computer-implemented method of claim 11, wherein the target machine-learned model is different from the subject machine-learned model, and wherein the target machine-learned model one of both of: contains more parameters as compared to the subject machine-learned model and consumes additional processor cycles to process an input as compared to the subject machine-learned model.

14. The computer-implemented method of claim 13, wherein the target machine-learned model has at least 2, 5, 10, or 100 times as many parameters as compared to the subject machine-learned model.

15. The computer-implemented method of claim 1, wherein evaluating, by the computing system, the model performance data for the subject machine-learned model comprises evaluating, by the computing system, one or more performance metrics of the subject machine-learned model relative to a validation dataset.

16. The computer-implemented method of claim 1, wherein evaluating, by the computing system, the model performance data for the subject machine-learned model is performed prior to convergence of the subject machine-learned model when training, by the computing system, the subject machine-learned model on the selected subset of training data.

17. The computer-implemented method of claim 1, wherein updating, by the computing system, the machine-learned data rating model based at least in part on the model performance data comprises performing, by the computing system, a meta-gradient optimization technique.

18. The computer-implemented method of claim 17, wherein the meta-gradient optimization technique uses a meta-optimization loss function, wherein the meta-optimization function is a same loss function as is used when training, by the computing system, the subject machine-learned model on the selected subset of training data.

19. The computer-implemented method of claim 1, wherein updating, by the computing system, the machine-learned data rating model based at least in part on the model performance data comprises performing, by the computing system, an evolutionary learning technique to update the machine-learned data rating model.

20. The computer-implemented method of claim 1, wherein updating, by the computing system, the machine-learned data rating model based at least in part on the model performance data comprises performing, by the computing system, an evolutionary strategies technique to update the machine-learned data rating model.

21. The computer-implemented method of claim 1, wherein updating, by the computing system, the machine-learned data rating model based at least in part on the model performance data comprises performing, by the computing system, a reinforcement learning technique to update the machine-learned data rating model.

22. The computer-implemented method of claim 1, wherein the training data instances included in the corpus of training data instances comprise one or both of:
multiple different single-modality training data instances respectively corresponding to multiple different data modalities; and
one or more multi-modal training data instances each corresponding to multiple different data modalities.

23. A computing system comprising one or more processors and one or more non-transitory computer-readable media that collectively store computer-executable instructions for performing operations, the operations comprising:
for each of a plurality of meta-optimization iterations:
obtaining, by the computing system, training data information descriptive of one or more training data instances included in a corpus of training data instances;
processing, by the computing system, the training data information descriptive of the one or more training data instances with a machine-learned data rating model to generate one or more training data scores respectively for the one or more training data instances;
selecting, by the computing system, a selected subset of training data instances from the corpus of training data instances based on the one or more training data scores;
training, by the computing system, a subject machine-learned model on the selected subset of training data;
after or during training the subject machine-learned model on the selected subset of training data, evaluating, by the computing system, model performance data for the subject machine-learned model; and
updating, by the computing system, the machine-learned data rating model based at least in part on the model performance data.

24. One or more non-transitory computer-readable media that collectively store a target machine-learned model, wherein the target machine-learned model has been trained on an optimized subset of training instances that were selected based on performance of operations, the operations comprising:
for each of a plurality of meta-optimization iterations:
obtaining, by a computing system, training data information descriptive of one or more training data instances included in a corpus of training data instances;
processing, by the computing system, the training data information descriptive of the one or more training data instances with a machine-learned data rating model to generate one or more training data scores respectively for the one or more training data instances;
selecting, by the computing system, a selected subset of training data instances from the corpus of training data instances based on the one or more training data scores;
training, by the computing system, a subject machine-learned model on the selected subset of training data;
after or during training the subject machine-learned model on the selected subset of training data, evaluating, by the computing system, model performance data for the subject machine-learned model; and
updating, by the computing system, the machine-learned data rating model based at least in part on the model performance data.
